(19) United States
(12) Patent Application Publication
(10) Pub. No.: US 2018/0142758 A1
(43) Pub. Date: May 24, 2018

(54) APPARATUS FOR DAMPENING A MAST ARM STRUCTURE HARMONICS

(71) Applicant: Robert Connell Frey, Norwood, MN (US)

(72) Inventor: Robert Connell Frey, Norwood, MN (US)

(21) Appl. No.: 15/357,227

(22) Filed: Nov. 21, 2016

(51) Int. Cl. F16F 15/02; F16F 7/10

(52) U.S. Cl. CPC F16F 15/02; F16F 7/10

(57) ABSTRACT

An apparatus having a damper mount device for holding a damper element being operable for dampening a mast arm structure harmonics or bounce by creating a wind vortex when interacting with wind. An extension member component extends the damper mount device above a mast arm structure onto which the damper mount device is installed into. A damper bracket assembly being configured to hold the damper element with an attachment means. A strap adapter assembly being configured to attach the damper mount device onto the mast arm structure. An adjustment ball implement being configured to form a ball-in-socket implement operable for a rotational adjustment or tuning of an orientation of the damper mount device and the damper element.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to support systems for signage, lighting, etc. that may be subjected to harmonics, or vibration, due to wind. More particularly, the invention relates to a device for dampening harmonics in a mast arm.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. In some fields, particularly construction, a mast arm may refer to a substantially horizontal member extending from a vertical member or structure. Examples of mast arms may include without limitation, a substantially horizontal beam to which traffic signals or signs may be attached or the portion of a streetlight that extends outwardly from the upright post. Many traffic control structures may be required to be designed with an emphasis on fatigue loading. For example, without limitation, the Manual on Urban Traffic Control Devices issued by the Federal Highway Administration typically recommends that devices comprising mast arms experiencing an excessive degree of bounce due to wind or effects of vortices be addressed. Wind harmonics are usually required to be addressed due to the possibility of weld stress and failure due to these harmonics. However, in addition to mast arm weld stress and failure, wind harmonics may cause other types of problems with the device such as, but not limited to, fatigue of equipment mounted to the mast arm, the inability to hold the mast arm steady for camera(s) mounted to the mast arm, fatigue of the support member(s) of the device, etc.

By way of educational background, an aspect of the prior art generally useful to be aware of is that in many cases contractors in the traffic installation industry currently use a piece of sheet metal mounted directly to the mast arm to address fatigue loading. A piece sheet of metal mounted directly to the mast arm may not be able to create a wind vortex capable of lifting or pushing the mast arm enough to correct wind harmonics. Furthermore, due to the fixed positioning of the sheet metal, one may expect that mounting a piece of sheet metal directly on the mast arm may not allow this technique to address wind flow from different directions. In addition, mounting a piece of sheet metal on the mast arm may run the risk of over adjusting the angle of the sheet metal as wind passes over the sheet metal, which may cause the mast arm to rotate in a circular motion and may cause damage to the mast arm over time.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1C illustrate an exemplary damper mount, in accordance with an embodiment of the present invention. FIG. 1A is a diagrammatic front view of the damper mount. FIG. 1B is a top perspective view of a damper bracket, and FIG. 1C is a diagrammatic top view of a flat strap adapter; and

FIGS. 2A and 2B illustrate an exemplary damper mount in use on a mast arm, in accordance with an embodiment of the present invention. FIG. 2A is a front perspective view, and FIG. 2B is a perspective view of the underside of the damper mount.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). The ordinary meaning of “substantially halfway” is thus reasonably close to or nearly at the midpoint between the forwardmost point of the upper or outsole and the rearwardmost point of the upper or outsole.

Similarly, the term “substantially” is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform’. The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter. Moreover, for any claim of the present invention which claims an embodiment “consisting essentially of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention may provide an adjustable damper mount device that may be attached to a mast arm structure. This damper mount device may secure a surface or other device that may create a wind vortex meant to dampen mast arm harmonics caused by wind. Dampening mast arm harmonics may help to prevent vibrations and bounce in the mast arm structure that may cause the integrity of the mast arm structure and other hardware components mounted on the mast arm structure to weaken and/or fail over time.

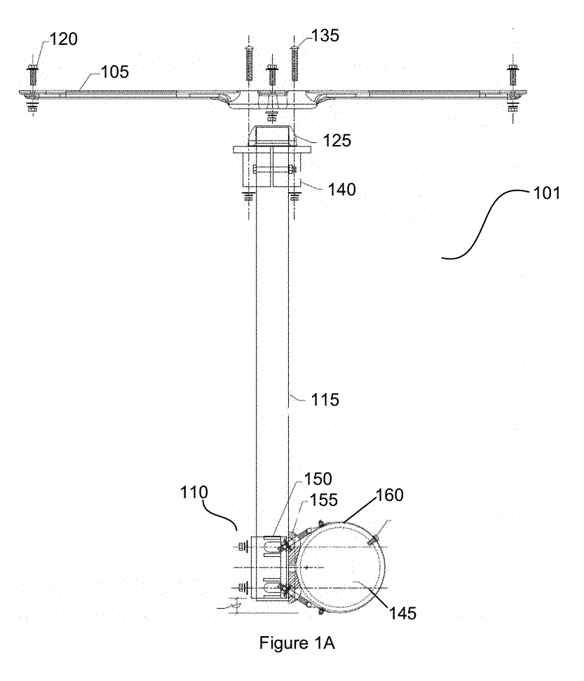

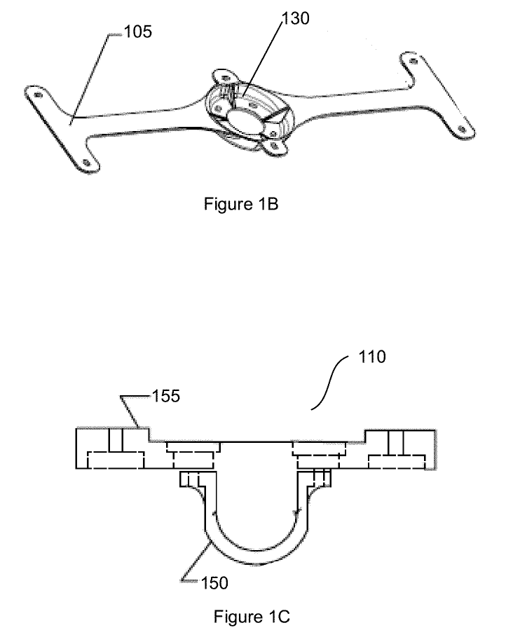

FIGS. 1A through 1C illustrate an exemplary adjustable damper mount device 101, in accordance with an embodiment of the present invention. FIG. 1A is a diagrammatic front view of an adjustable damper mount device 101. FIG. 1B is a top perspective view of an adjustable damper bracket 105 assembly, and FIG. 1C is a diagrammatic top view of a flat strap adapter 110 assembly. In the present embodiment, the adjustable damper mount device 101 comprises castings made from new ingot grade 319 and 356 certified aluminum and stainless steel hardware with galvanized nuts to help prevent galling and enable easy installation. It is contemplated that in some embodiments, the damper mount device may be manufactured using virtually any material that provides greater strength and can maintain its integrity and intended function including, but not limited to, different aluminum alloys, stainless steel, other metals, various different plastics, fiberglass, other composite materials, etc.

Referring to FIG. 1A, in the present embodiment adjustable damper mount device 101 comprises damper bracket 105 assembly, an extension member 115 component, and flat strap adapter 110 assembly. In typical use of the present embodiment, a damper element (not shown), such as, but not limited to, a flat aluminum sheet, sheets made of other materials, a cylindrical or square tube, dampers with moving parts, or other devices that may be able to create a wind vortex when interacting with wind, may be attached to damper bracket 105 assembly using attachment means 120. It is contemplated that a multiplicity of suitable elements may be used for attachment means 120 including, but not limited to, bolts with lock washers and hex nuts, other types of bolt systems, screws, rivets, clamps, straps, adhesives, etc. Damper bracket 105 assembly may be attached to extension member 115 component with an adjustable joint comprising an adjustment ball 125 implement, which may enable an installer to perform a rotational adjustment of an attached damper to tune the damper for site conditions. Referring to FIGS. 1A and 1B, a round cradle 130 part on damper bracket 105 assembly may be placed over adjustment ball 125 implement and held in place with attachment means 135 such as, but not limited to bolts or screws. A clamp adapter 140 tool connects adjustment ball 125 implement to extension member 115 component to provide a rotational and customized ball-in-socket adjustment and positioning of the damper mount device 101. As a result, the adjustable damper mount device provides an easy installation and maintenance of the damper element installed on a mast arm structure.

In use, to avoid an over adjustment of the plane of the damper, the clamp adapter 140 may be installed to allow the adjustment ball 125 to properly fit over the extension member 115 or pipe, to allow the damper mount casting to be bolted to a 2″ extension member. After the clamp adapter has been secured, the adjustment ball may be applied to the top of the extension member 115 over the clamp adapter 140. The damper mount casting may rest over the adjustment ball, adjusted to the desired degree, then bolted to the clamp adapter. The flat strap adapter 110 may attach the damper mount device 101 to the mast arm 145 or pole with straps that may be installed around the mast arm or pole and secured to the flat strap adapter casting. If additional field adjustment is needed, the bolts may be loosened to allow movement and then refastened to secure final adjustment.

In the present embodiment, damper bracket 105 is substantially flat and shaped to accept a damper that is shaped as a flat rectangle. Those skilled in the art will readily recognize, in light of and in accordance with the teachings of the present invention that damper brackets in some alternate embodiments may be shaped differently to accept dampers of various different shapes. In additional embodiments, the damper bracket may be made by casting into various different shapes. For example, without limitation, in one embodiment a rounded bracket may be implemented to hold a damper that is cylindrical in shape or dish shaped. In another such embodiment, a channel shaped bracket may be used to hold a vertically mounted sheet. In other embodiments flat circular dampers may be used. In the present embodiment, extension member 115 is shown as a cylindrical pipe with a 2″ diameter. It is contemplated that pipes of various different sizes may be used as the extension member in some alternate embodiments. Furthermore, in other alternate embodiments materials other than cylindrical pipe may be used for the extension member including, without limitation, square tubing, wooden dowels, perforated materials that may allow wind to pass through, etc. In an alternative embodiment, the extension member 115 is a height adjustable extension member including, but no limited to, telescopic extension member, segmented extension member, etc.

Referring to FIGS. 1A and 1C, damper mount 101 may be strapped onto a mast arm 145 using a flat strap adapter 110 assembly, which comprises a pipe fetter 150 part, a flat universal hub casting 155 part, and two adjustable strap 160 parts. Pipe fetter 150 may be used to attach extension member 115 to hub casting 155 to which straps 160 may be attached. This may enable extension member 115 component, and the rest of damper mount device 101, to be easily attached to mast arm 145 structure, which may have a round cross section, using straps 160 while minimizing or eliminating the need to drill holes into mast arm 145. In the present embodiment, a 5/16″ lock bolt and spring washer assembly 165 may be tapped through strap 160 and into mast arm 140 to maintain grounding requirements of the National Electric Code. Most mast arms are painted which does not allow a metal to metal ground contact to be applied. It is contemplated that some embodiments may be implemented with a multiplicity of suitable means for attaching the damper mount to a mast arm or other structure. For example, without limitation, a flat bracket without a strap may be used to attach a damper mount to a square mast arm or a flat surface. In other embodiments the damper mount device may be welded directly onto the mast arm. In the present embodiment, to help avoid accidental damage to mast arm 145 structure, it may be desirable to mount adjustable damper mount device 101 so that extension member 115 component does not extend below the bottom of the mast arm 145 structure. In some applications it may be acceptable to mount the adjustable damper mount device so that the extension member component does extend below the bottom of the mast arm structure depending on factors such as, but not limited to, the shape of the mast arm, the type of damper element being mounted, the size of the damper mount, etc. In the present embodiment anti-seize lubricant may be applied to all threaded surfaces. Moreover, no set screws are typically used for the installation of an adjustable damper mount 101 device.

Set screws may be used, but it has been found over time that they are not optimal because of loosening issues that run the risk of mounting failure which may result in objects to fall causing serious injury or death to a person and property. Also, because of the loosening issues, extensive maintenance is required.

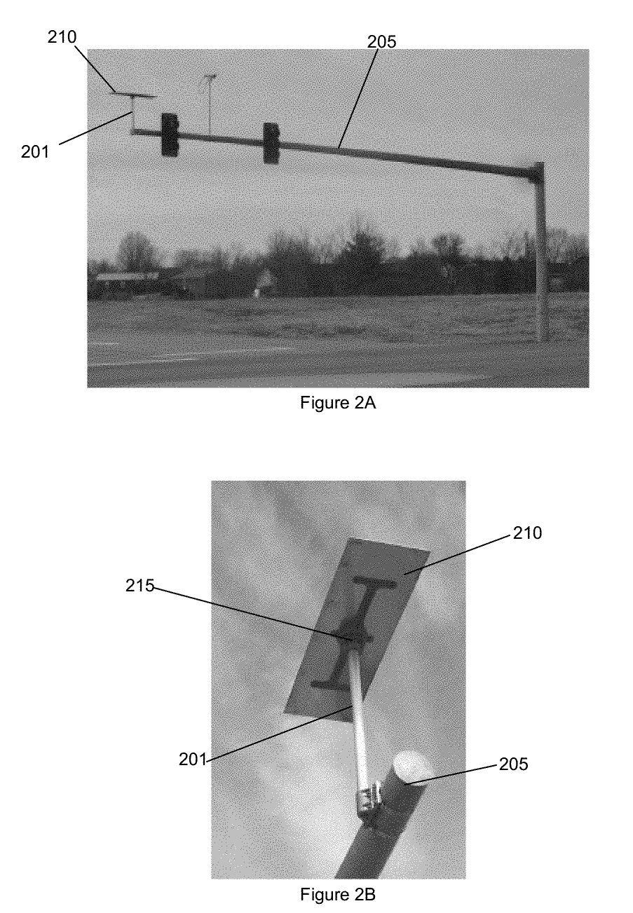

FIGS. 2A and 2B illustrate an exemplary damper mount 201 in use on a mast arm 205, in accordance with an embodiment of the present invention. FIG. 2A is a front perspective view, and FIG. 2B is a perspective view of the underside of damper mount 201. In the present embodiment, a flat sheet of metal may be used as a damper element 210 designed for dampening harmonics, or bouncing, in mast arm 205 by creating a wind vortex off its surface, which may be tilted with respect to typical wind flow. This vortex may act on damper element 210 to lift up or push down mast arm 205 to counteract the effect of wind on mast arm 205. In typical use of the present embodiment, damper mount 201 may be installed at the farthest possible mounting location on mast arm 205, which may provide the greatest leverage. In addition, it may be desirable for damper 210 to be located approximately 12″ above the highest obstruction on mast arm 205. This may allow for maximum wind torque and control and may typically enable air to pass freely above and below damper 210. Those skilled in the art will readily recognize, in light of and in accordance with the teachings of the present invention, that in some alternate embodiments the damper may be positioned in a multiplicity of suitable locations. For example, without limitation, in some embodiments the damper mount may be located closer to the support structure rather than at the furthest possible mounting location. In some embodiments the extension member may be sized so that the damper may be positioned closer than 12″ or further than 12″ from the highest obstruction on the mast arm. In many instances, the extension member may be field measured and cut to fit the circumstances of the particular application.

If damper 210 is mounted having a level surface, for example, without limitation, parallel to mast arm 205, damper 210 may not be able to create a wind vortex to counteract the effects of wind. In some cases a level damper may even exacerbate the harmonics caused by wind. In typical use of the present embodiment, once damper mount 201 is attached to mast arm 205, an adjustment ball 215 may allow for rotational adjustment of damper 210. Adjusting the angle of damper 210 may enable damper 210 to be tuned according to the wind load on mast arm 205. Initial adjustment may typically rotate damper 210 to be between 2% and 3% off horizontal; final adjustment may be field specific taking into consideration multiple factors including, but not limited to field conditions and the length of mast arm 205. This final site specific tuning can usually effectively stabilize mast arm 205 and anything mounted to it such as, but not limited to, cameras, signals, lights, signs, detectors, infrared units, etc.

In operation, in high speed wind locations, adjust the plane at a lower grade, in lower wind speed locations, adjust the plane at a higher grade. Adjustment does not need to be changed depending on the weather conditions. The damper mount may address harmonics in a mast arm. The damper may be bolted on to the mount for a secure and permanent solution. The adjustment ball is to provide movement while adjustments are made and may be unmovable when final fastening is completed. If conditions call for and adjustment to be made, the adjustment hardware may be loosened, the adjustment made, and the hardware tightened to its new permanent adjusted position.

In the present embodiment, adjustment ball 215 may be designed to not be over adjusted so that damper 210 is not positioned at too much of an angle, where damper 210 may become caught up in the wind and create a circular motion in mast arm 205 instead of a bounce. In an alternative embodiment, the adjustment ball may not be a complete sphere to avoid over adjusting the damper element. The adjustment ball is configured to have enough surface area to allow proper adjustments, but not too much surface area that would risk over adjustment. The damper mount casting makes contact with the clamp adapter when adjusted to the maximum grade. The adjustment ball may be used as a round surface to provide movement and the bolts may fasten the desired grade adjustment in place at the four fastening points.

It is contemplated that a multiplicity of suitable means may be used in other embodiments of the present invention to enable the damper bracket to be positioned at an appropriate angle including, without limitation, a pre-angled mount, an elbow pipe to adjust the degree of the flat surface, a hinge on the mount to adjust the degree of the flat surface, etc. In some embodiments an adjustment ball type mount may be incorporated with other signal mounting equipment such as, but not limited to, traffic lights, cameras, signs, etc. It is further contemplated that other means for adjusting portions of the damper mount may be incorporated into some embodiments of the present invention; for example, without limitation, a telescoping pipe to adjust the height of the damper or a telescoping flat surface to adjust the width or length of the damper.

In the present embodiment, damper mount 201 may help to avoid stress on the welds and body of mast arm 205, specifically stresses that may arise when mast arm 205 encounters aggressive elements of the weather, particularly wind. Depending on wind direction, damper 210 may either pull up on mast arm 205 or push down on mast arm 205 causing a stabilizing effect rather than a bouncing effect from harmonics. Damper 210 mounted with damper mount 201 in accordance with the foregoing description may help to prevent weld fatigue and failure in mast arm 205 and may increase the stability of equipment mounted on mast arm 205 as well as the stability of mast arm 205 itself. This added stability of mast arm 205 may lead to reduced maintenance over the life of mast arm 205 and potentially a longer lifespan for mast arm 205. A damper sheet on a casting may provide greater strength and stability, as opposed to a sheet bolted directly to the mast arm or pole. When fastening a piece of sheet metal directly to a mast arm, in many cases there are fewer points of contact when fastened. The damper sheet on a casting strengthens and utilizes a more rigid surface area per square inch due to the six points of fastening and the broad placement of the points of contact with the damper mount casting and the damper sheet.

Those skilled in the art will readily recognize, in light of and in accordance with the teachings of the present invention, that virtually any type of unit may be mounted to a damper mount as described in the foregoing. For example, without limitation, the relatively flat surface of the damper bracket may enable an installer to mount a reasonably heavy piece of material or equipment to the damper mount. It is contemplated that damper mounts may also be used to mount solar panels to provide additional power to lights and signals on a mast arm, dishes and other communication devices, cameras, traffic signals, signs, etc. In another embodiment, a damper mount may be used to make a mast arm extension with a signal bracket on the end instead of a damper bracket. Yet another embodiment may incorporate a sign mount bolting the damper mount to the strap adapter rather than a pipe fetter.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a device for dampening harmonics in a mast arm according to the present invention will be apparent to those skilled in the art. Various aspects of the invention have been described above by way of illustration, and the specific embodiments disclosed are not intended to limit the invention to the particular forms disclosed. The particular implementation of the device for dampening harmonics in a mast arm may vary depending upon the particular context or application. By way of example, and not limitation, the devices for dampening harmonics in a mast arm described in the foregoing were principally directed to traffic sign and signal implementations; however, similar techniques may instead be applied to reduce harmonics in various different applications including, without limited to, boat masts, bridges, or cell towers, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a damper element being configured to be operable for dampening a mast arm structure harmonics or bounce by creating a wind vortex when interacting with wind; and
a damper mount device, said damper mount device being configured to hold the damper element, wherein said damper mount device is an adjustable damper mounting device comprising:
an extension member component being configured to extend the damper mount device above a mast arm structure onto which the damper mount device is installed into, said extension member component comprises at least a first end and a second end;
a damper bracket assembly being disposed proximate the first end of the extension member component, said damper bracket assembly comprises a damper bracket casting assembly being configured to hold the damper element with an attachment means;
a strap adapter assembly being disposed proximate the second end of the extension member, said strap adapter assembly being configured to attach the damper mount device onto the mast arm structure; and
an adjustment ball implement, said adjustment ball implement being disposed proximate a tip of the first end of the extension member and below the damper bracket assembly being configured to form a ball-in-socket implement operable for a rotational adjustment or tuning of an orientation of the damper mount device and the damper element.

2. The apparatus of claim 1, further comprising a clamp adapter tool, clamp adapter tool being configured to connect the adjustment ball implement to the extension member component.

3. The apparatus of claim 1, in which said damper bracket assembly comprises a round cradle part, said round cradle part being configured to hold the ball implement in place, to form the socket for the ball implement, being operable to enable the rotational adjustment or tuning of the orientation of the damper mount device.

4. The apparatus of claim 1, wherein the strap adapter assembly being configured to be operable to at least minimize the need to drill holes into the mast arm structure.

5. The apparatus of claim 1, in which the strap adapter assembly comprises:
a hub casting part;
a pipe fetter part being configured to attach the extension member component to the hub casting part; and
a strap part being configured to attach to the hub casting part, wherein the strap part being operable for adjustably attaching the damper mount device onto the mast arm structure.

6. The apparatus of claim 5, further comprising a lock bolt and spring washer assembly being configured to maintain grounding requirements by tapping through the strap part and into a mast arm structure to provide electrical contact between the damper mount device and the mast arm structure.

7. The apparatus of claim 5, wherein the strap part comprises a width adjustable strap part being configured to enable an effortless attachment of the damper mount device and the damper element to the mast arm structure.

8. The apparatus of claim 1, in which the extension member component is a height adjustable extension member.

9. The apparatus of claim 1, in which the damper mount device being configured to be welded directly onto the mast arm structure.

10. The apparatus of claim 1, in which the damper element is further configured to dampen harmonics or bouncing, in the mast arm structure, by generally creating a wind vortex off a surface of the damper element, wherein the wind vortex created by the damper element is operable to lift up or push down the mast arm structure to counteract the effect of the wind on the mast arm structure.

11. The apparatus of claim 1, in which the ball implement comprises an incomplete sphere being configured to avoid over adjusting an orientation of the damper element.

12. A device comprising:
means for dampening a mast arm structure harmonics; and
means for mounting said dampening means to the mast arm structure, wherein said mounting means is an adjustable mounting means comprising:
means for extending said mounting means above the mast arm structure, said extending means comprises at least a first end and a second end;
means for holding said dampening means;
means for attaching said holding means to said extending means;
means for attaching the extending means onto the mast arm structure; and
means for adjusting or tuning the mounting means.

13. The device of claim 12, further comprising means for creating electrical contact between the mounting means and the mast arm structure, wherein said means for creating electrical contact is configured to abide with grounding requirements.

14. The device of claim 12, in which said holding means comprises a means for holding the adjusting means in place.

15. The device of claim 14, in which said holding means and said adjusting means is configured to form a ball-in-socket configuration being operable to enable the rotational adjustment or tuning of the mounting means.

16. A device comprising:
a damper element being operable for dampening a mast arm structure harmonics or bounce by creating a wind vortex when interacting with wind; and
a damper mount device, said damper mount device being operable for holding the damper element, wherein said damper mount device is an adjustable damper mounting device comprising:
an extension member component being configured to extend the damper mount device above a mast arm structure onto which the damper mount device is installed into, said extension member component comprises at least a first end and a second end;
a damper bracket assembly being disposed proximate the first end of the extension member component, said damper bracket assembly being configured to hold the damper element with an attachment means;
a strap adapter assembly being disposed proximate the second end of the extension member, said strap adapter assembly being configured to attach the damper mount device onto the mast arm structure; and
an adjustment ball implement, said adjustment ball implement being disposed proximate a tip of the first end of the extension member and below the damper bracket assembly being configured to form a ball-in-socket implement operable for a rotational adjustment or tuning of an orientation of the damper mount device and the damper element.

17. The device of claim 16, further comprising a clamp adapter tool, clamp adapter tool being configured to connect the adjustment ball implement to the extension member component.

18. The device of claim 16, in which said damper bracket assembly comprises a round cradle part, said round cradle part being configured to hold the ball implement in place, to form the socket for the ball implement, being operable to enable the rotational adjustment or tuning of the orientation of the damper mount device.

19. The device of claim 16, wherein the damper mount device being configured to be operable for mounting at least one of a camera, a speed detector, and a sign.

20. The device of claim 18, in which the strap adapter assembly comprises:
a hub casting part;
a pipe fetter part being configured to attach the extension member component to the hub casting part; and
a strap part being configured to attach to the hub casting part, wherein the strap part is an adjustable strap part being operable for adjustably attaching the damper mount device onto the mast arm structure.
